(19) United States
(12) Patent Application Publication
(10) Pub. No.: US 2016/0272418 A1
(43) Pub. Date: Sep. 22, 2016

(54) SLIDE ON BODY WASTE BIN

(71) Applicant: BARENTHAL NORTH AMERICA, INC., Whippany, NJ (US)

(72) Inventor: Hongyuan Han, New Vernon, NJ (US)

(21) Appl. No.: 15/070,369

(22) Filed: Mar. 15, 2016

Related U.S. Application Data
(60) Provisional application No. 62/135,328, filed on Mar. 19, 2015.

(51) Int. Cl. B65F 1/08; B65F 1/14; B65F 1/06

(52) U.S. Cl. CPC B65F 1/08; B65F 1/06; B65F 1/1646; B65F 1/1615; B65F 2250/112

(57) ABSTRACT

Various slide-on bins are described. In one embodiment, the slide-on bin includes a base portion, an inner body and an outer shell. The inner body has a basket portion that extends between an open first end and a closed second end. The outer shell is configured to be lowered over the inner body and seated in the base portion enclosing the inner body.

The slide-on bins may be, in horizontal cross-section, round, oval, rectangular, square, etc. In some embodiments, the outer shell may be a brushed stainless steel, polished stainless steel, or a two-tone combination of brushed and polished stainless steel. The slide-on bins may also include additional features such as lids.

### STATEMENT REGARDING FEDERALLY SPONSORED RESEARCH OR DEVELOPMENT

N/A

### BACKGROUND

Various embodiments relate generally to receptacles, such as trash bins, and, more specifically, relate to receptacles having multiple parts.

This section is intended to provide a background or context. The description may include concepts that may be pursued, but have not necessarily been previously conceived or pursued. Unless indicated otherwise, what is described in this section is not deemed prior art to the description and claims and is not admitted to be prior art by inclusion in this section.

Many receptacles are used with disposable liners or bags. However, a liner may not fit the receptacle well and include additional length that extends too far past the lip of the receptacle. This can create an unsightly bunching and/or cover the receptacle in an unappealing manner. Bunching may provide a place for items put in the receptacle to snag and/or create a mess.

Some conventional receptacles may include an inner container which can be removed in order to place a liner on it. However, the excess length of the bag can bunch up and/or fall off the inner container when reinserting the inner container into the receptacle.

Additionally, receptacles are often located where they can be conveniently accessed. This often places the receptacle in open view. Thus, the look of the receptacle can then limit design options for the whole room. However, keeping additional receptacles in order to provide alternative options can take up a lot of space.

It would thus be highly desirable to provide a receptacle which can easily accommodate a variety of liner lengths in a way that does not create the problems noted above. It would also be highly desirable to provide a receptacle that offers a degree of artistic customization in order to maximize the fit of the receptacle within the intended setting, to enable the appearance of the receptacle to change in accordance with changes in the intended setting, or to enable the appearance of the receptacle when relocated to a new setting.

### SUMMARY

The below summary is merely representative and non-limiting.

The above problems are overcome, and other advantages may be realized, by the use of the embodiments.

In a first aspect, an embodiment provides a slide-on bin. The slide-on bin includes a base portion and an inner body having a basket portion that extends between an open first end and a closed second end. The slide-on bin also includes an outer shell. The outer shell is configured to be lowered over the inner body and seated in the base portion enclosing the inner body.

In a further aspect, the slide-on bin also includes a lid.

In another aspect, the slide-on bin is, in horizontal cross-section, round, oval, rectangular, square or triangular-shaped.

### BRIEF DESCRIPTION OF THE SEVERAL VIEWS OF THE DRAWINGS

Aspects of the described embodiments are more evident in the following description, when read in conjunction with the attached Figures.

FIG. 1 illustrates a first embodiment of a slide on body waste bin.

FIG. 2 illustrates the first embodiment with a bag.

FIG. 3 illustrates a step of assembling the first embodiment.

FIG. 4 illustrates another step of assembling the first embodiment.

FIG. 5 illustrates the first embodiment when fully assembled.

FIG. 6 illustrates another view of the first embodiment when fully assembled.

FIGS. 7A-7D, collectively referred to as FIG. 7, show an overview of various embodiments.

FIG. 8 illustrates an embodiment of a five liter, oval, slide on body waste bin having a brushed finish.

FIG. 9 illustrates the basket of the embodiment of FIG. 8.

FIG. 10 illustrates the bottom of the bin of the embodiment of FIG. 8.

FIG. 11 illustrates another view of the bottom of the bin of the embodiment of FIG. 8.

FIG. 12 illustrates an embodiment of a twelve liter, oval, slide on body waste bin having a two-tone finish.

FIG. 13 illustrates the basket of the embodiment of FIG. 12.

FIG. 14 illustrate embodiments of a five liter, oval, slide on body waste bin having a two-tone finish and a plastic tent-style lid.

FIG. 15 illustrates a further embodiment of a five liter, oval, slide on body waste bin having a two-tone finish and a stainless-steel tent-style lid.

FIG. 16 illustrates another embodiment of a five liter, oval, slide on body waste bin having a two-tone finish and a stainless-steel and plastic tent-style lid.

FIG. 17 shows an overview of an embodiment having a flat-style lid.

### DETAILED DESCRIPTION

This patent application claims priority from U.S. Provisional Patent Application No. 62/135,328, filed Mar. 19, 2015, the disclosure of which is incorporated by reference herein in its entirety.

Various embodiments provide a receptacle which can easily accommodate a variety of liner lengths. In one, non-limiting embodiment the waste bin is made up of at least two components which, when combined, create a lidless open top waste bin. The bin contains an inner body and an outer body. A disposable garbage bag may be placed into the inner body and the excess bag is rolled over the edge onto the outside of the inner body. The outer body may then be slid over the inner body covering the excess length of the bag. This both prevents the excess bag from becoming a problem and provides a more appealing appearance for the bin.

This embodiment also allows the consumer to easily remove and replace the bag without coming into contact with a dirty part of the used bag since the part of the bag between the inner body and the outer body has not come into contact with the contents of the bag.

In some embodiments, a close fit between the lip of the inner body and the underside of the outer body holds the bag in place. This keeps the bag from sliding into the bin as items are added to the bin and helps keep the bin clean. Alternatively, the inner body may include a bag cinch or other structure to secure the bag.

The receptacles as illustrated in the accompanying figures are trash receptacles, such as may be found in the home and in particular in a kitchen setting. However, such receptacles could also be adapted for use in professional settings such as offices or other workplaces including artists' studios, commercial kitchens, medical offices, etc.

Given the likely use of the receptacle for receiving refuse, it is preferred that the bin be resilient, pliant, dirt and stain resistant, and easily cleaned. In one embodiment, portions of the bin are formed of plastic such as polyurethane or the like. Portions of the bin may be tinted or pigmented to a variety of colors or combinations of colors. A pattern may be formed in or pressed onto the outer surface of the bin, and the outer surface may have a flat (e.g., light-absorbent) surface, an enamel (e.g., light-reflecting) surface, or a surface that is some combination of both.

Additional components and features may be added to enhance the functionality or appearance of the receptacle, such as lids, bag cinches, air holes, air-fresheners, a non-slip base, etc.

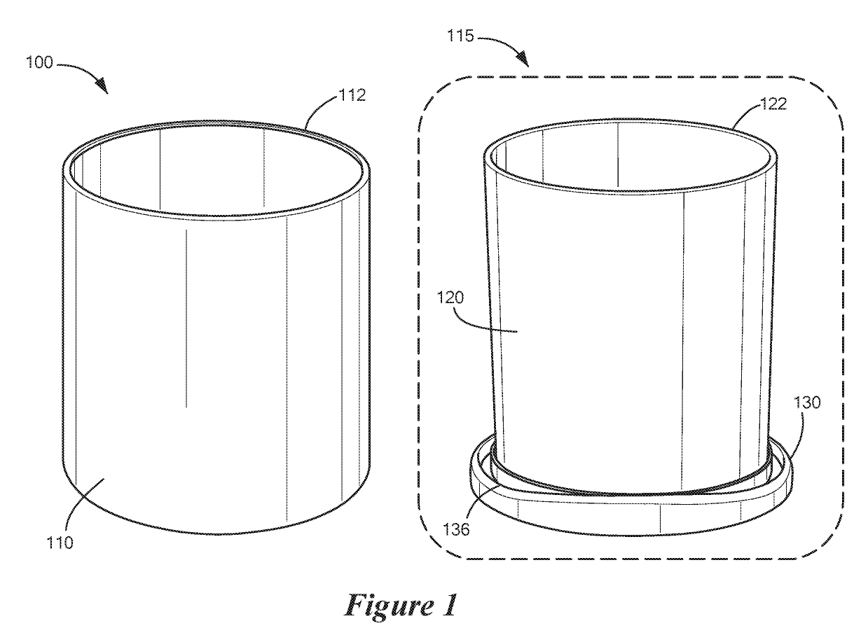

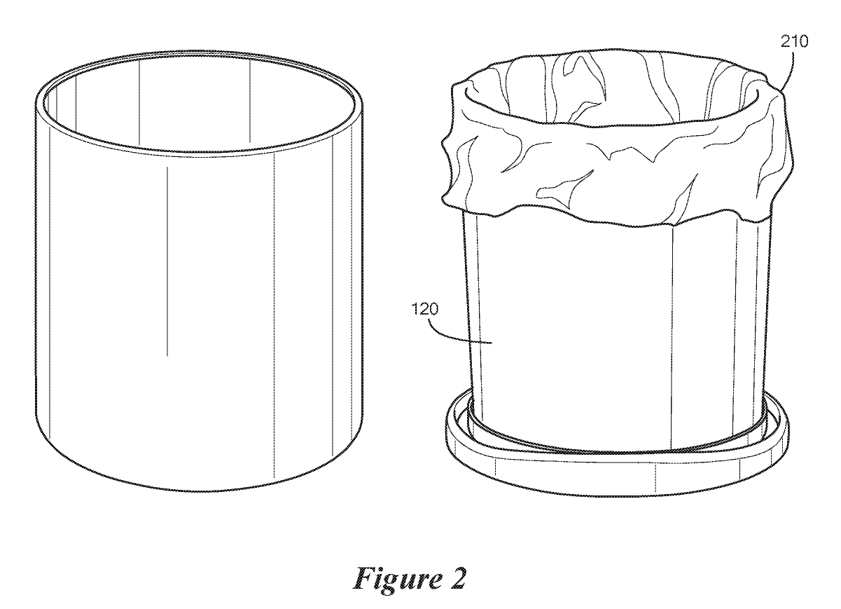

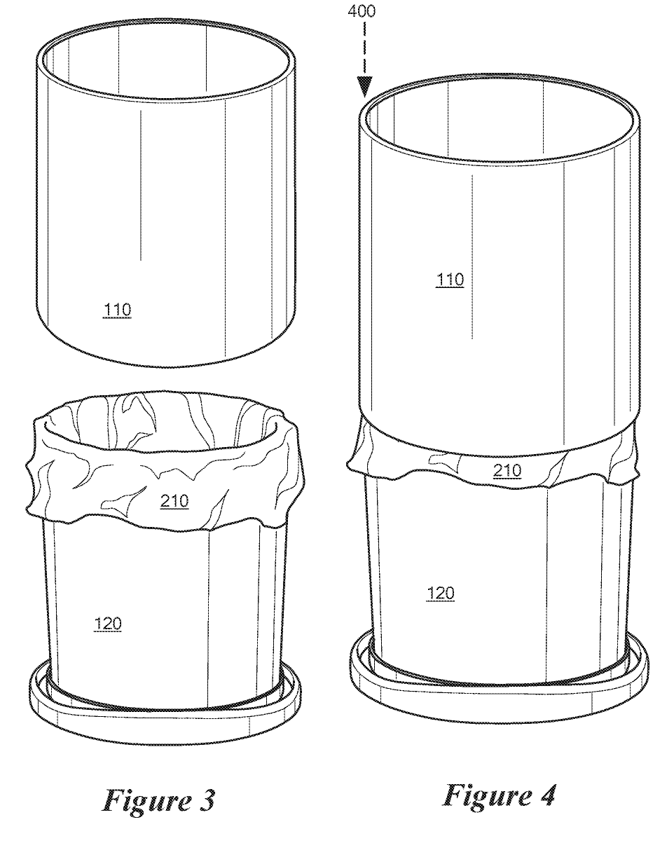

FIG. 1 illustrates one embodiment of a slide on body waste bin 100. As shown, the waste bin 100 is oval with both the outer body 110 (or exterior component/shell) and the basket portion 120 (or interior component) of the inner body 115 sharing the oval shape. The inner body 115 includes a base portion 130 which may be detachable or may be integrated into the structure of the inner body 115. FIG. 2 illustrates the slide on body waste bin 100 of FIG. 1 after a bag 210 (or liner) has been placed in the basket portion 120. The excess length of the bag 210 has been rolled over the lip 122 of the basket portion 120. The outer body 110 can then be aligned with the inner body 115 (as shown in FIG. 3) and then lowered (moved in direction 400) over the inner body 115 (as shown in FIG. 4) until the outer body 110 sits in the base portion 130. By lowering the outer body 110 over the basket portion 120, the excess length of the bag 210 is prevented from bunching up and/or falling off the basket portion 120.

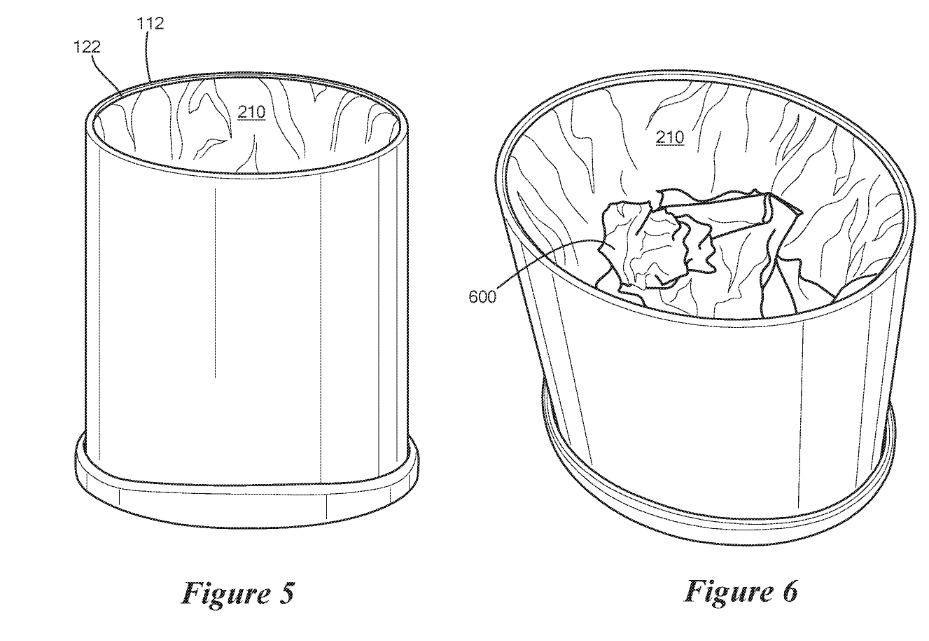

The resulting configuration is shown in FIG. 5. The outer body 110 is shown sitting in a recess 136 of the base portion 130 of the inner body 115. The bag 210 is secured by the interaction of the lip 122 of the basket portion 120 and the inner edge 112 of the outer body 110. Additionally, the excess length of the bag 210 is hidden from view. As shown in FIG. 6 items 600 may be easily placed in the waste bin 100 without interference from the excess length of bag 210.

Once the bag 210 is full, the outer body 110 may be lifted off the inner body 120 in a reverse process and the previously covered length of bag 210 can be easy grasped in order to remove the bag 210 while avoiding touching the contents 600 of the waste bin 100.

In further embodiments, the waste bins may have various sizes and/or shapes. As an example, other, non-limiting embodiments may be either oval or round shaped; and either 5 L or 12 L sized. Still further sizes and shapes may also be used, such as triangular, wedge or corner-shaped and square or rectangular shaped.

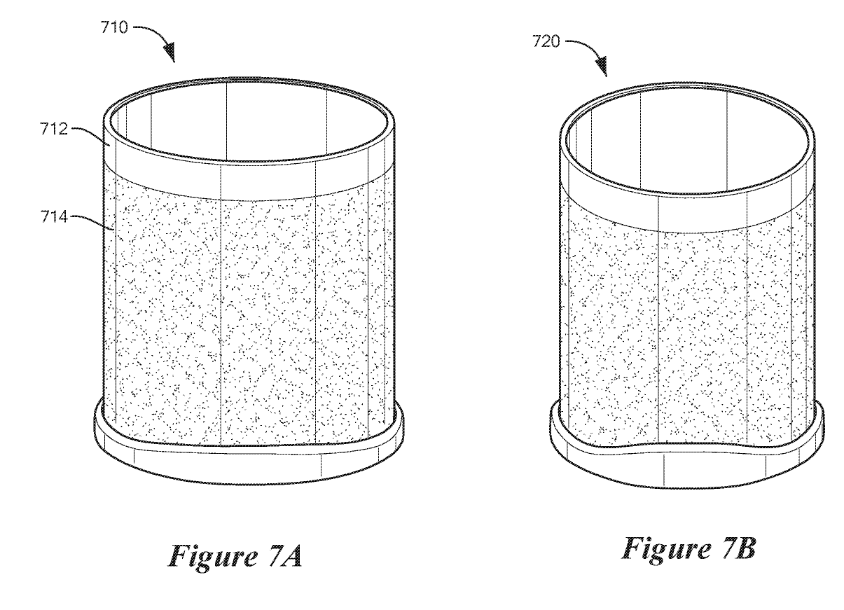

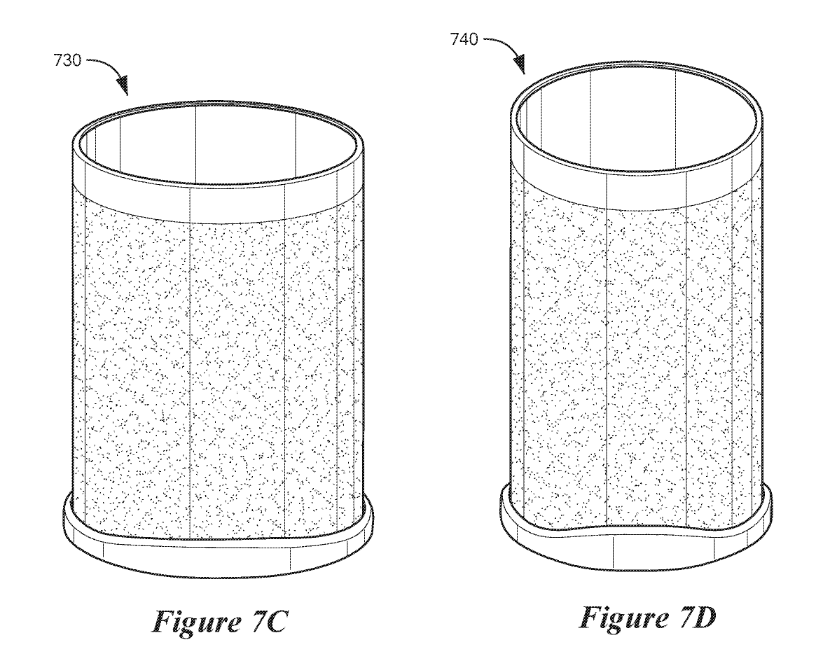

The outer body offers many decorative options. As non-limiting examples, two-tone finished stainless steel (SS) trash-bins are shown in FIG. 7. In FIG. 7A, a 5 liter (5 L) oval bin 710 is shown. The bin 710 includes a polished finish portion 712 and a brushed finish portion 714. FIG. 7B illustrates a 5 L round bin 720, FIG. 7C illustrates a 10 L oval bin 730 and FIG. 7D illustrates a 10 L round bin 740. Various materials, finishes and/or decorations may also be used, for example, a smaller, upper brushed finish and a lower mirrored finish; patterned finishes (such as checker-board, etc.); etc.

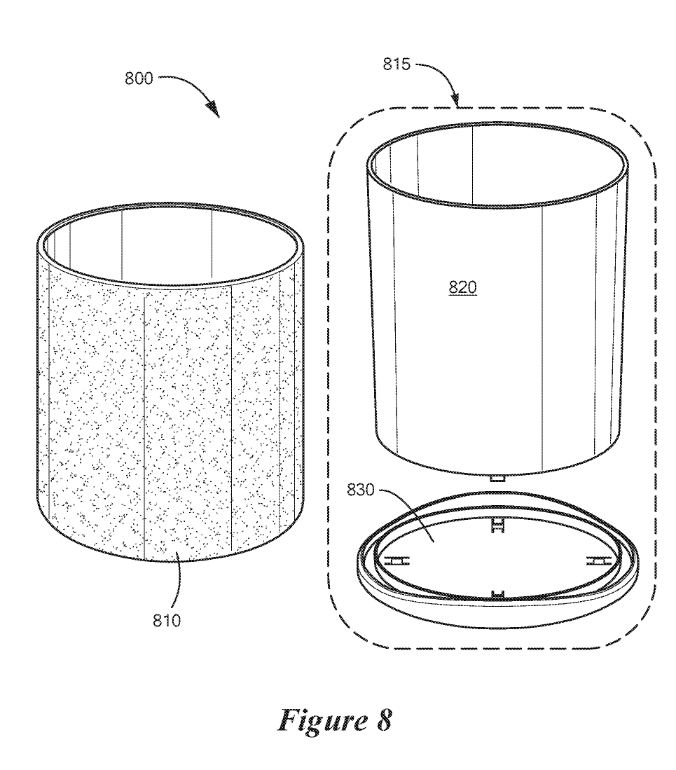

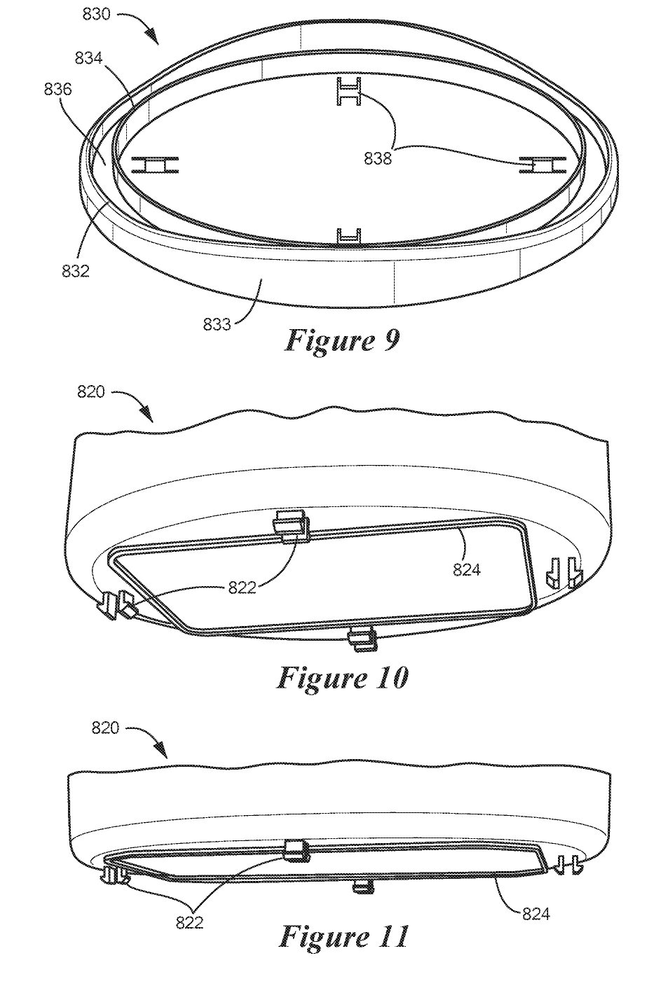

FIGS. 8-11 illustrate an embodiment of a 5 L, oval, slide on body waste bin 800 having a brushed finish. As shown, the inner body 815 is made up of a basket portion 820 and a detachable base portion 830. FIG. 9 shows the base portion 830 which includes structures 838 configured to interact with the basket portion 820. The matching structures on the basket portion 820 are shown in FIGS. 10 and 11. In this non-limiting embodiment the basket portion 820 and base portion 830 feature four interlocking structures.

Further embodiments may include other structures or features to secure the base portion 830 and the basket portion 820.

Additionally, the base portion 830 includes an outer rim 832 and an inner rim 834 which together define a seat 836 that is configured to receive the outer body 810. The outer rim 832 also includes areas 833 having enlarged heights which can assist in aligning the outer body 810 when lowered into the seat 836.

As shown in FIGS. 10-11, the underside of the basket portion 820 also includes a raised lip 824. This raised lip 824 can help level the basket portion 820 when attached to the base potion 830. The raised lip 824 also prevents bottom of basket portion 820 from being in contact with the upper surface of the base portion trapping moisture, etc.

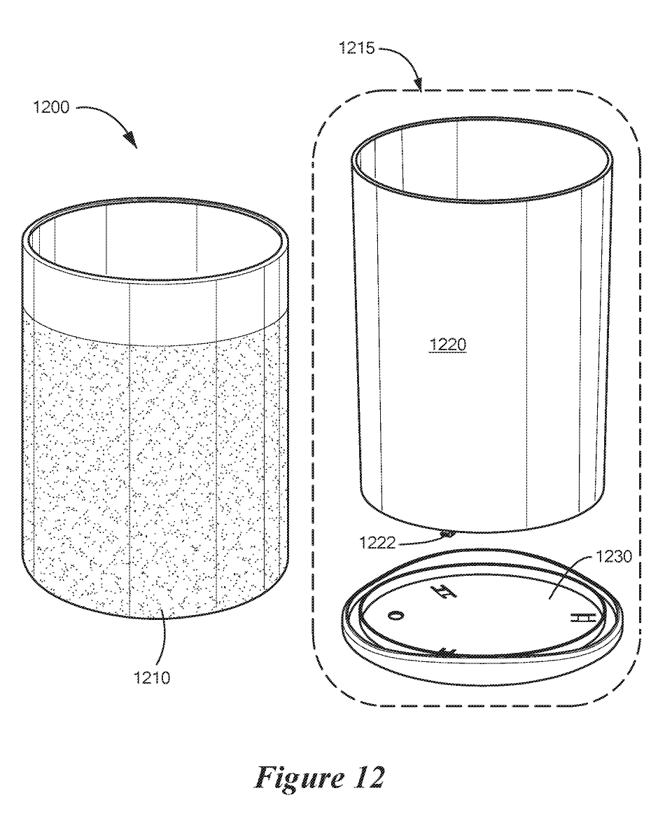

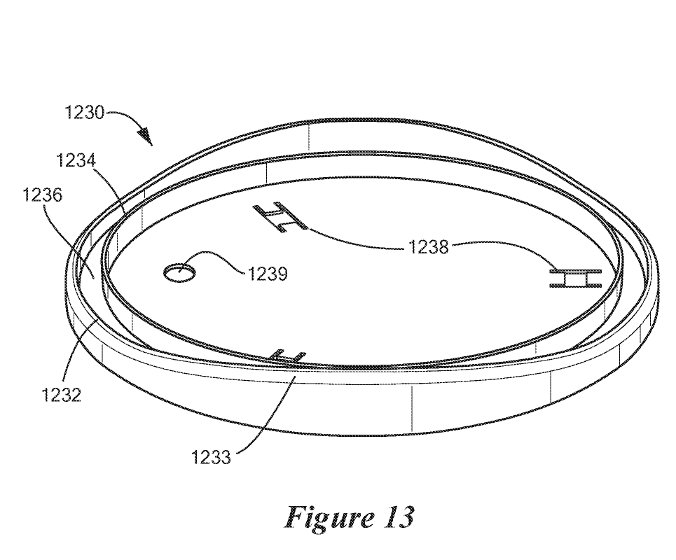

FIGS. 12-13 illustrate an embodiment of a 12 L, oval, slide on body waste bin 1200 having a two-tone finish. As shown in FIG. 12, this embodiment also includes an outer body 1210 and an inner body 1215 with a detachable base portion 1230. In this non-limiting embodiment, there are three interlocking structures 1238 on the base portion 1230 (shown in greater detail in FIG. 13) which function with structures 1222 on the bottom of the basket portion 1220 to secure the two portions 1220, 1230.

Similar to the base portion 830 of FIGS. 8-11, the base portion 1230 includes an outer rim 1232 and an inner rim 1234 which together define a seat 1236 that is configured to receive the outer body 1210. The outer rim 1232 also includes areas 1233 having enlarged heights which can assist in aligning the outer body 1210 when lowered into the seat 1236. Additionally, base portion 1230 also includes a drain hole 1239.

In further embodiments, the waste bin may include a lid. The lid may be a portion of the outer body or the lid may be a separate component which may or may not attach to the outer body. In one, non-limiting embodiment, the lid may include structures to secure the lid to the outer body. In another, non-limiting embodiment, the lid may be configured to rest on the outer body.

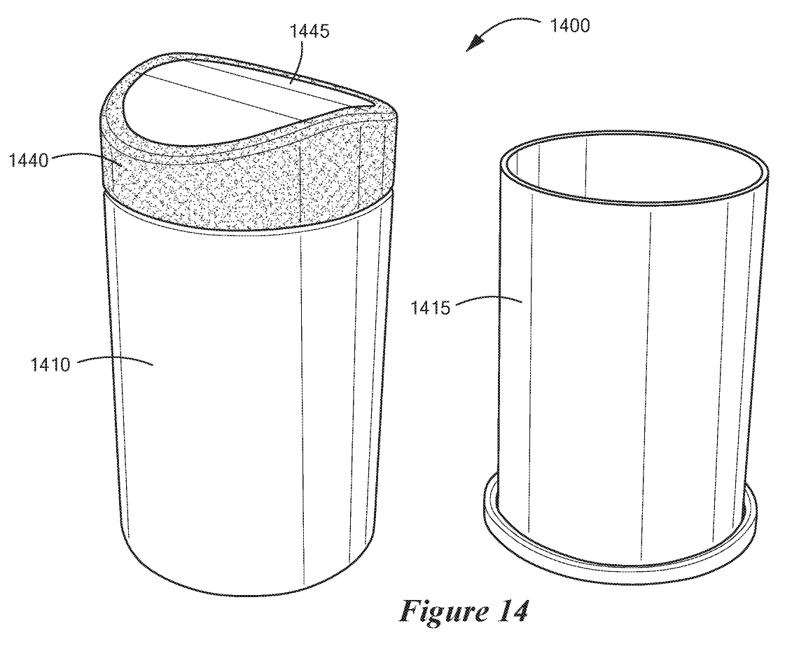

FIG. 14 illustrates an embodiment of a 5 L, oval, slide on body waste bin 1400 having a brushed finish on the outer body 1410 and a tent-style lid. The lid is shown as having a plastic frame 1440 and a plastic swing lid 1445.

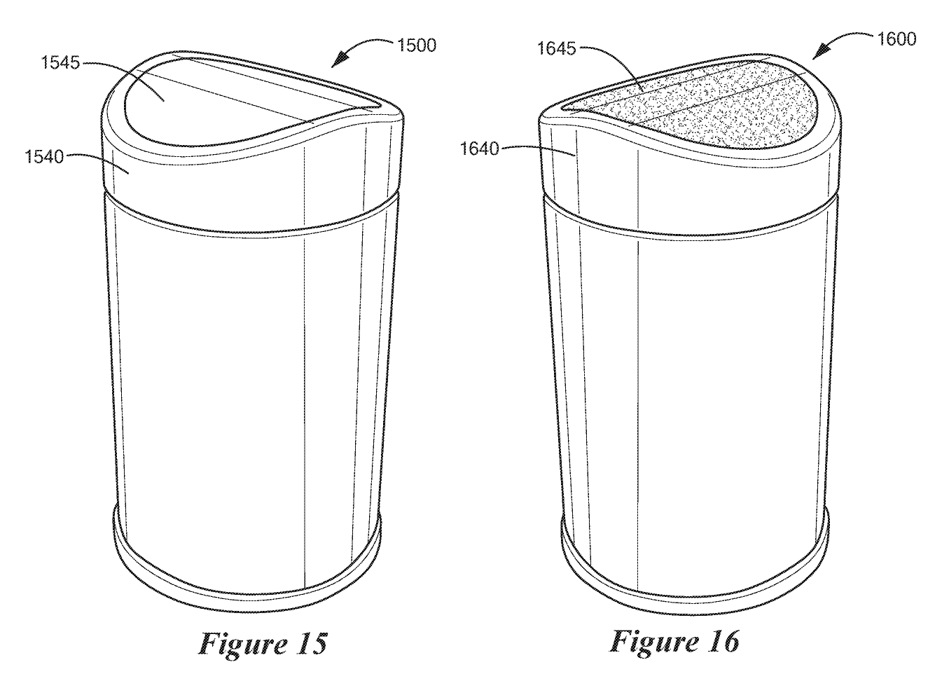

The embodiments in FIGS. 15-16 include further non-limiting embodiments, for example, where both the frame 1540 and swing lid 1545 are SS (FIG. 15) or where the frame 1640 is SS and swing lid 1645 is plastic (FIG. 16).

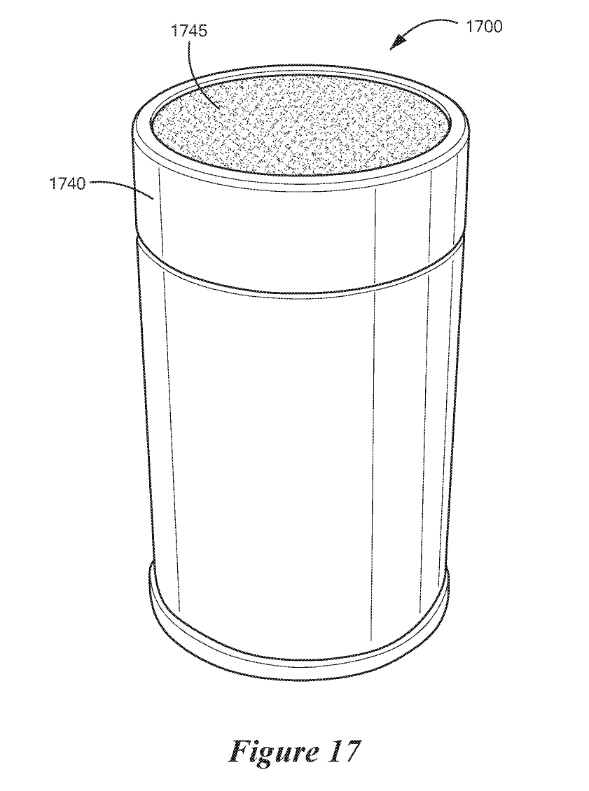

The lid may also be made with different features, for example, in FIG. 17 the embodiment shown is a bin 1700 that has a flat-style lid 1745. As discussed above, the lid 1745 and frame 1740 may be made with various materials and finishes.

Further embodiments include waste bins of various shapes, for example, in addition to round and oval, the waste bins may be semi-round, rectangular, square, triangular, etc. The waste bins may also be of various sizes in addition to the 5 L or 12 L sizes illustrated, for example, a smaller form which may be used on top of a table or counter.

In additional embodiments, the components of the waste bin can be made of various materials, such as, but not limited to: metal (e.g., stainless steel, carbon steel, copper, etc.); plastics (such as polyurethane, polypropylene, etc.); compressed paper or wood pulp and/or a combination of materials. The outer body may also be colored or accented with designs; painted; stenciled; engraved; etched; polished; brushed; decorated with in-mould labeling; etc.

Features or structures may also be added to some embodiments. These may include wheels, handles, a pedal to lift a lid, a spring to hold the lid open, locking structures to secure the lid in a closed position (such as for waste bins to be used outdoors), locking structures to secure the outer body over the inner body, dampers to allow gradual lid closing, weights (which may be embedded in the base), motion detectors (such as to automatically open the lid), lights, various devices and/or structures to operate with such devices (e.g., a paper shredder), etc.

The foregoing description has been directed to particular embodiments. However, other variations and modifications may be made to the described embodiments, with the attainment of some or all of their advantages. It will be further appreciated by those of ordinary skill in the art that modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

What is claimed is:

1. A slide-on bin comprising:
a base portion;
an inner body having a basket portion, wherein the basket portion extends between an open first end and a closed second end; and
an outer shell configured to be lowered over the inner body and seated in the base portion enclosing the inner body.

2. The slide-on bin of claim 1, wherein the inner body further comprises structures configured to attach to the base portion.

3. The slide-on bin of claim 2, wherein the structures comprise plastic clips configured to attach to openings in the base portion.

4. The slide-on bin of claim 1, wherein the inner body comprises the base portion.

5. The slide-on bin of claim 1, wherein the base portion comprises an inner ring and an outer ring, the inner ring and the outer ring defining a groove,
wherein the groove is configured to receive the outer shell.

6. The slide-on bin of claim 1, wherein the base portion comprises a retaining structure to detachably secure the outer shell.

7. The slide-on bin of claim 1, wherein the outer shell is, in horizontal cross-section, one of: round, oval, rectangular, square, triangular and wedge-shaped.

8. The slide-on bin of claim 1, wherein the outer shell is one of: brushed stainless steel, polished stainless steel, two-tone stainless steel, and plastic.

9. The slide-on bin of claim 1, wherein the outer shell has an edge configured to, with a lip of the basket portion, define a circumferential gap,
wherein the circumferential gap is configured to secure a liner when the outer shell is seated in the base portion.

10. The slide-on bin of claim 1, further comprising a lid.

11. The slide-on bin of claim 10, wherein the lid comprises a frame configured to allow the lid to pivot around an axis.

12. The slide-on bin of claim 11, wherein the outer shell comprises the frame.

13. The slide-on bin of claim 11, wherein the lid is flat.

14. The slide-on bin of claim 11, wherein the lid is arched.

15. The slide-on bin of claim 11, wherein the frame is one of: brushed stainless steel, polished stainless steel, two-tone stainless steel, and plastic.

16. The slide-on bin of claim 11, wherein the lid is one of: brushed stainless steel, polished stainless steel, two-tone stainless steel, and plastic.

17. The slide-on bin of claim 11, wherein the frame further comprises a securing structure configured to hold the lid in a closed position.

18. The slide-on bin of claim 1, wherein the base portion comprises a weight.
